(19) United States
(12) Patent Application Publication
(10) Pub. No.: US 2022/0271377 A1
(43) Pub. Date: Aug. 25, 2022

(54) ENERGY STORAGE SYSTEM

(71) Applicant: Carl Freudenberg KG, Weinheim (DE)

(72) Inventors: Peter Kritzer, Forst (DE); Mark Boggasch, Laudenbach (DE); Daniela Woll, Bensheim (DE); Thomas Kramer, Rimbach (DE); Tanja Heislitz, Hofheim (DE); Armin Striefler, Oehringen (DE); Bjoern Hellbach, Birkenau (DE); Tim Leichner, Moerstadt (DE)

(21) Appl. No.: 17/634,566

(22) PCT Filed: Jul. 23, 2020
(86) PCT No.: PCT/EP2020/070857

§ 371 Date: Feb. 11, 2022

(30) Foreign Application Priority Data
Aug. 14, 2019 (DE) 10 2019 121 850.0

(51) Int. Cl. H01M 50/229; H01M 50/213; H01M 50/233; H01M 10/613

(52) U.S. Cl. CPC H01M 50/229; H01M 50/213; H01M 50/233; H01M 10/613

(57) ABSTRACT

An energy storage system includes at least one storage cell. The at least one storage cell is provided, at least in sections, with a casing. The casing consists of plastic, and the casing is provided with a material for increasing a thermal conductivity.

### CROSS-REFERENCE TO PRIOR APPLICATIONS

This application is a U.S. National Phase application under 35 U.S.C. § 371 of International Application No. PCT/EP2020/070857, filed on Jul. 23, 2020, and claims benefit to German Patent Application No. DE 10 2019 121 850.0, filed on Aug. 14, 2019. The International Application was published in German on Feb. 18, 2021 as WO 2021/028189 A1 under PCT Article 21(2).

### FIELD

The invention relates to an energy storage system comprising at least one storage cell, wherein the storage cell is provided with a casing, at least in sections, wherein the casing consists of plastic.

### BACKGROUND

Energy storage systems are widely used and are used in particular as rechargeable accumulators for electrical energy in mobile and stationary systems. More specifically, energy storage systems in the form of rechargeable accumulators are also used in portable electronic devices, such as in measuring devices, medical devices, tools, or consumer articles. Furthermore, energy storage systems in the form of rechargeable accumulators are used to provide electrical energies for electrically-driven means of transport. Electrically-driven means of transport can be two-wheelers, four-wheelers, e.g., cars, or also utility vehicles, such as buses, trucks, rail vehicles, or forklifts. In addition, energy storage systems are also used in ships and aircraft.

It is also known to provide energy storage systems in the form of rechargeable accumulators in stationary applications, e.g., as backup systems in network systems and for storing electrical energy from renewable energy sources.

A frequently used energy storage system is a rechargeable battery in the form of a lithium-ion accumulator. Such energy storage systems, like other rechargeable accumulators, also usually have several storage cells arranged in a housing. Several storage cells arranged in a housing and electrically connected to one another form a module.

Further known energy storage systems are, for example, lithium-sulfur accumulators, solid accumulators, or also metal-air accumulators.

Energy storage systems in the form of rechargeable accumulators have the maximum electrical capacity only within a limited temperature spectrum. If the optimal temperature spectrum is exceeded or undershot, the electrical capacity of the energy storage system decreases greatly; at least the functionality of the energy storage system is impaired.

In particular, excessively high temperatures can lead to damage to the energy storage system. In this context—particularly in the case of lithium-ion cells—the so-called thermal runaway is known. In this case, high amounts of thermal energy and gaseous degradation products are released in a short period of time, resulting in high pressure and high temperatures in the storage cells. This effect is problematic particularly in the case of energy storage systems with high energy density and, accordingly, many storage cells in a narrow space, as is necessary, for example, in energy storage systems for providing electrical energy for electrically-driven vehicles. The problem of thermal runaway accordingly increases as a function of the increasing amount of energy of individual storage cells and as a result of increasing the packing density of the storage cells arranged in a housing.

During thermal runaway of a storage cell, temperatures in the range of 600° C. or more can occur locally within the energy storage system over a period of about 30 seconds. By suitable measures, the energy transfer to adjacent storage cells is to be reduced enough that the temperature of the adjacent storage cells does not rise too much. Preferably, the temperature of the adjacent storage cells is to be at most 100° C. However, this value is highly dependent upon the chemicals used for the accumulator and upon the heat input from the cell housing into the cell coil. Accordingly, the temperature can also be significantly above or below 100° C.

Although the affected storage cell is also irreversibly damaged in this case, the damage can, however, be prevented from spreading to adjacent storage cells (avoidance of thermal propagation).

As a measure, for this purpose, it is known, e.g., from WO 2019/046871, to arrange a cooling device between the storage cells, wherein the device is designed to be planar and fit snugly against the sheath of the storage cells in sections.

### SUMMARY

In an embodiment, the present invention provides an energy storage system. The energy storage system comprises at least one storage cell. The at least one storage cell is provided, at least in sections, with a casing. The casing consists of plastic, and the casing is provided with a material for increasing a thermal conductivity.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows exemplary storage cells with a tubular casing, wherein the casing covers the sheath of the storage cell once completely and once partially;

FIG. 2 shows an exemplary casing with a contouring on the inside;

FIG. 3 shows various variants of casings with contourings on the inside;

FIG. 4 shows exemplary casings contoured on the inside and outside;

FIG. 5 shows star-shaped casings contoured on the inside and/or outside;

FIG. 6 shows an exemplary casing for accepting two storage cells;

FIG. 7 shows an exemplary casing for accepting a plurality of storage cells;

FIG. 8 shows exemplary casings with longitudinal ribs on the outside; and

FIG. 9 shows an arrangement of storage cells with casing.

### DETAILED DESCRIPTION

Embodiments of the present invention provide an energy storage system that has improved operational reliability.

The energy storage system according to exemplary embodiments of the present invention comprises at least one storage cell, wherein the storage cell is provided, at least in sections, with a casing, wherein the casing consists of plastic, wherein the casing is provided with a material for increasing the thermal conductivity.

In preferred embodiments, the casing is elastic.

The casing absorbs the heat emitted by the storage cells and conducts it away to a cooling device, e.g., to a cooler through which a cooling medium flows. Since the casing consists of plastic, the casing can be produced cost-effectively in large quantity. Furthermore, due to the elastic design, the casing abuts tightly on the outer side of the storage cell so that direct contact exists between the storage cell and the casing, which in turn is advantageous for heat conduction.

Most plastics, however, have relatively poor thermal conductivity. Due to the material introduced into the casing for increasing the thermal conductivity, the thermal conductivity of the casing formed from plastic improves significantly. This ensures, in particular, that heat spikes arising in a storage cell can be reliably dissipated. The thermal conductivity of the casing designed according to preferred embodiments of the present invention is at least 0.6 W/(m·K).

The storage cell may be a round cell. Storage cells in the form of lithium-ion accumulators are frequently designed as round cells. They can be produced in high quantities and in good quality. In particular, round cells having a diameter of 18 mm and a length of 65 mm or a length of 70 mm and a diameter of 21 mm are particularly common. The round cell of smaller diameter is predominantly used in applications in which a high voltage is required with simultaneously limited system energy. For example, such round cells are used in electric vehicles and also in power tools. Fields of application of the larger round cells are, for example, utility vehicles, such as forklifts. However, designs of round cells with larger or smaller lengths and diameters are also known.

Round cells have a cylindrical sheath, a bottom, and a cover on the side opposite the bottom. The bottom and the sheath are usually made of uniform material and in one piece. The cover is a separate component and electrically insulated from the sheath or the bottom. Accordingly, one pole is usually assigned to the cover, and the other pole is assigned to the sheath or bottom. In the embodiment described above, both the sheath and the bottom of the storage cell are electrically conductive. In order to prevent unintentional short-circuiting and creeping currents within the energy storage system, it is therefore known to insulate the housing of the storage cells outside of the contacts. The insulation usually consists of an insulating polymeric material, which can be designed, for example, as a shrink tube which surrounds the sheath of the storage cell. Accordingly, the casing according to the invention can also be designed in such a way that it surrounds the sheath of the storage cell at least in sections. The casing is preferably designed to be electrically insulating.

Since the casing is designed to be elastic, it can easily be pushed onto the cylindrical sheath of the round cell and also follow dimensional changes of the storage cell occurring during operation, e.g., during charging or discharging, and can thus prevent an impermissibly high internal pressure from building up within the storage cell. In principle, it is conceivable that the casing be formed from a textile fabric—for example, a nonwoven. Such fabrics are compressible and easy to install.

The casing is furthermore designed to be temperature-resistant and equipped to withstand a temperature load of 600° C. over a period of at least 30 seconds. In this case, the casing is to surround the storage cell after such a temperature load, such that an impermissibly high heat transfer to adjacent storage cells is prevented.

The casing may be made of elastomeric material. It is true that elastomeric materials frequently have only limited thermal conductivity. However, equipping the material according to the embodiments of the invention with a material for increasing the thermal conductivity results in a thermal conductivity high enough to be capable of dissipating the heat generation of the cells during normal operation.

According to a further advantageous embodiment, an endothermically-acting material, which, when a temperature is exceeded, absorbs thermal energy once, and therefore thermal peak loads which arise, for example, during thermal runaway, is introduced into the elastomeric material.

Advantageous elastomeric materials are, for example, silicone-based elastomers or ethylene propylene diene monomers (EPDM). Silicone elastomers are highly temperature-resistant and have a certain resistance to flaming. When EPDM is used, it is preferred if the material is additionally equipped with a flame-retardant material. Thermoplastic elastomers are also conceivable.

The casing may be designed to be tubular. A casing designed in this way is advantageous in particular in connection with round cells.

Alternatively, the casing can be designed from sheeting. This allows the casing to be adapted to a plurality of shapes of various storage cells. During assembly, the sheet-shaped casing is placed around the storage cell at least in sections. Subsequently, the overlapping regions of the casing can be bonded to one another.

The casing can be contoured on the outside. In particular, it is conceivable for the casings to be designed on the outside in such a way that the casings of several adjacent storage cells come into close contact with one another over a large area. This ensures heat transport across a plurality of storage cells. Depending upon the design, the contouring can also result in an enlarged surface, so that improved heat dissipation in the direction of the surroundings results.

The casing can be designed to be flat on the outside, at least in regions. With respect to the casing for a round cell, the casing can be designed, for example, in a D-shape along the outer contour. Due to the flattened portion of the outer contour of the casing in regions, a large abutment surface of the casing on an adjacent component results, which is, in particular, advantageous when the storage cells with the casing are to be arranged on a planar cooling element. In this case, the casing can be contoured on the outside and/or inside such that a uniform thickness of the material is provided around the circumference of the casing.

The material for increasing the thermal conductivity can be an electrically-insulating, inorganic filler. Such materials can be found, for example, in the group of ceramic materials.

Improvement in the thermal conductivity of the elastomeric material of the casing is achieved when fillers, such as AI₂O₃, boron nitride, or mixtures of these two, are used. With aluminum oxide (AI₂O₃) as filler, thermal conductivities in the range of 2 to 3 W/(m·K) can be realized, for example. However, the protective function of these fillers is limited in the event of a failure (thermal runaway).

Particularly advantageous are materials that undergo an endothermic reaction when heated above 100° C., the reaction being triggered, for example, by recrystallization or the release of crystal water. When a material-specific decomposition temperature is exceeded, such compounds release water, while absorbing energy. Particular preference is given here to aluminum hydroxide (AI(OH)₃) because, with this filler, in mixtures (compounds), thermal conductivities of up to 1 W/(m·K) can be realized, and this filler releases crystal water in the temperature range between 200° C. and 250° C. This endothermic reaction markedly reduces the heat transfer between adjacent storage cells in the event of damage.

Also advantageous are materials which release gases, e.g., CO₂, at temperatures above 100° C. The release of gas within the casing leads to an additional, one-time heat cushion and slows down the heat transfer between the storage cells. Such materials can, for example, be found in the group of carbonates—for example, K₂CO₃, Na₂CO₃, or CaCO₃. Mixtures of these materials are also conceivable.

Due to the high specific heat absorption of the decomposing materials, the casing can be designed to be thin and space-saving. Nevertheless, the casing has good thermal insulation in the direction of adjacent storage cells in the event of damage.

In this case, it is, in particular, advantageous that the casing with the material that decomposes in the event of damage has high thermal conductivity under normal operating conditions, but, in case of damage, a high amount of energy is absorbed within the casing by the endothermic reaction, without high amounts of heat being transferred to adjacent storage cells. In normal operating conditions, however, the heat emitted within the storage cell is dissipated in the direction of a cooling device.

The material can be designed in such a way that it functions as a latent heat accumulator. Such latent heat accumulator materials are, for example, phase-change materials, wherein the material is preferably selected such that the temperature of the phase transition between solid and liquid is at least 100° C.

The material for increasing the thermal conductivity can be introduced into a planar matrix, wherein the matrix is embedded in the casing. The matrix may, for example, consist of a thermally-resistant nonwoven. It is advantageous here that a particularly homogeneous distribution of the material over the surface of the casing is possible, so that large quantities of material can be introduced into the casing. The material can be introduced into the matrix by customary processes, such as knife coating or padding. The matrix can alternatively be arranged near the surface or along a surface.

In preferred embodiments, the casing has a thickness of at most 5 mm, and in more preferred embodiments the thickness of the casing is, particularly preferably, less than 1.5 mm.

The casing may be contoured on the side facing the storage cell. In this context, it is conceivable to integrate longitudinal ribs into the casing. These can be designed as channels leading to the storage cell. On the one hand, the longitudinal ribs simplify the assembly of the casing. On the other hand, the longitudinal channels can ensure that the released gases are discharged in a targeted manner from the material of the casing in the direction of the longitudinal ribs during an endothermic reaction of the correspondingly-designed material, without undesirably high pressures or stresses forming in the material.

The casing may also be designed such that it accepts more than one storage cell and electrically insulates the storage cells from one another. For example, a casing for two storage cells can be formed in the shape of an eight.

As a result of the contouring applied to the inside of the casing, regions which abut on the storage cells, and other regions which are spaced apart from the storage cells, can form in the casing. Cavities which improve the thermal insulation of the casing—in particular, in the event of a fault—are formed thereby. In addition, it is conceivable that the cavities directly adjacent to the storage cell be used as cooling channels through which a gaseous or liquid cooling medium is passed.

Such structuring results, for example, when the device is structured in the shape of ribs. Such a design also results when the device is profiled in a wave-shape over the circumference on the inside. In both embodiments, it is advantageous that they can be produced in an extrusion process.

The casing can have channels which run within the casing. In preferred embodiments, the channels run along the casing. Such channels improve the insulating effect of the casing.

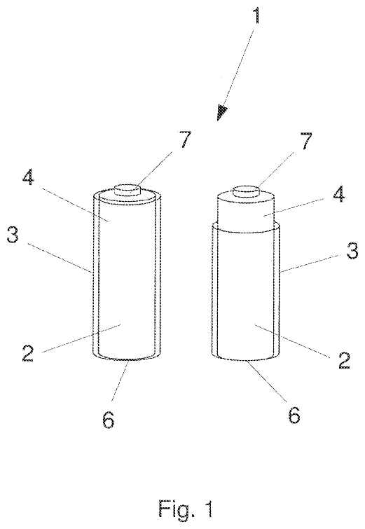

The figures show an energy storage system 1 comprising at least one storage cell 2. In the present embodiments, the storage cell 2 is an accumulator for storing electrical energy. The accumulator of the embodiment of FIG. 1 is preferably a lithium-ion accumulator. The accumulator may likewise be a lithium-sulfur accumulator, a solid-state accumulator, or a metal-air accumulator.

In the present embodiments, the storage cell 2 is designed as a round cell and, according to a first embodiment, has a diameter of 18 mm and a length of 65 mm and, in a second embodiment, has a length of 70 mm and a diameter of 21 mm. The storage cells 2 have a housing with a bottom 6 and a sheath 4, and are closed by a cover 7 on the side opposite the bottom 6. The cover 7 and sheath 4 or bottom 6 are electrically insulated from one another. The storage cell 2 is contacted via the bottom 6 and the cover 7.

The energy storage system 1 further comprises a housing in which a plurality of storage cells 2 are arranged. In this case, the storage cells 2 are arranged upright next to one another.

Storage cell 2 is provided, at least in sections, with a casing 3. The casing 3 is designed to be elastic and consists of plastic; in the present embodiment, the casing 3 consists of a silicone elastomer. In order to increase the thermal conductivity, the elastomeric material—the silicone elastomer—is provided with a material for increasing the thermal conductivity. The material for increasing the thermal conductivity is an electrically-insulating, inorganic filler—in the present case, a ceramic material.

In this context, advantageous ceramic materials are inorganic hydroxides or oxide hydroxides—for example, Mg(OH)₂, AI(OH)₃, or AIOOH. These release water vapor at higher temperatures. Aluminum hydroxide (AI(OH)₃) is particularly advantageous since, in it, as filler, thermal conductivities of up to 1 W/(m·K) can be realized in compounds, and it releases crystal water in a temperature range of 200° C. to 250° C.

The casing 3 made of silicone elastomer and ceramic material for increasing the thermal conductivity is designed to be electrically insulating.

In the present embodiments, the casing 3 is designed to be tubular and can be produced in the extrusion process. According to an advantageous alternative embodiment, the casing 3 is formed from sheeting.

In exemplary embodiments the casing 3 has a material thickness of 1.2 mm.

FIG. 1 shows a first embodiment of the energy storage system 1. On the left side, FIG. 1 shows a first storage cell 2, which is provided with a casing 3, which surrounds the sheath 4 of the storage cell 2. As a result of this embodiment, the sheath 4 is electrically insulated from the surroundings—in particular, from further storage cells. The right-hand side shows a further storage cell 2, which is likewise provided with a casing 3. However, the latter surrounds the sheath 4 only in sections.

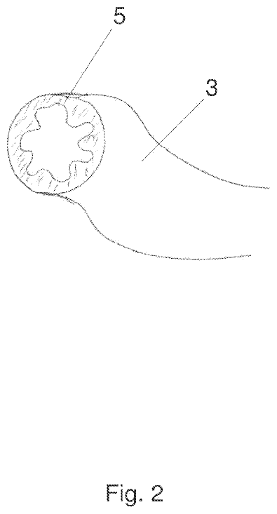

FIG. 2 shows a casing 3, which is contoured on the side 5 facing the storage cell 2. In the present embodiment, the contouring is designed in the form of longitudinal ribs. These form channels opening onto the storage cell 2. According to an advantageous embodiment, the channels form several chambers through which cooling medium can flow.

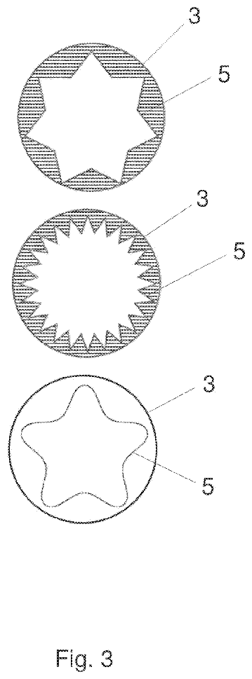

FIG. 3 shows further embodiments of the casing 3 as shown in FIG. 2. In the present embodiments, the contouring on the inside of the casing 3 is of a serrated design and is star-shaped when viewed in plan view.

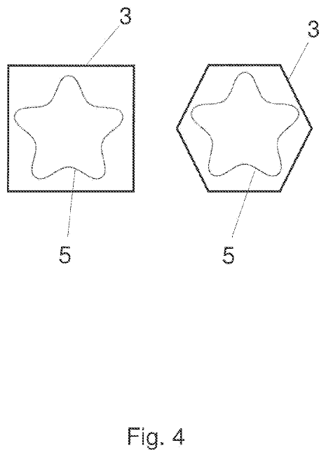

FIG. 4 shows a development of the casing 3 shown in the lower section of FIG. 3. In the present embodiment, the casing 3 is contoured on the outside. According to a first embodiment, the casing 3 is designed to be rectangular along the outer contour. According to a further embodiment, the casing 3 is designed to be hexagonal on the outside. This makes it possible to arrange several casings 3 next to one another and above one another without intermediate spaces.

According to an advantageous development, the casing 3 has both a contouring on the inside, as shown, for example, in FIGS. 2 and 3, and a contouring on the outside, as shown, for example, in FIG. 4.

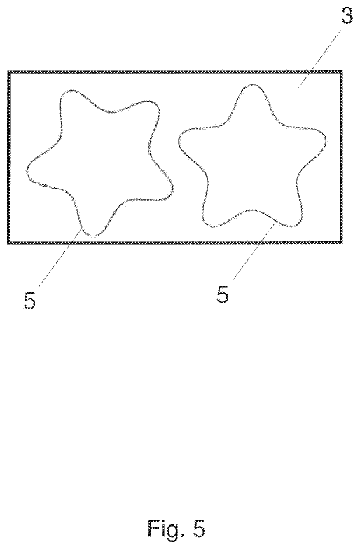

FIG. 5 shows developments of the casing 3 shown in FIG. 4. In the present embodiment, the casing 3 is contoured in a star-shape on the outside in the left exemplary embodiment. According to the right embodiment, the casing 3 is designed to be round on the outside.

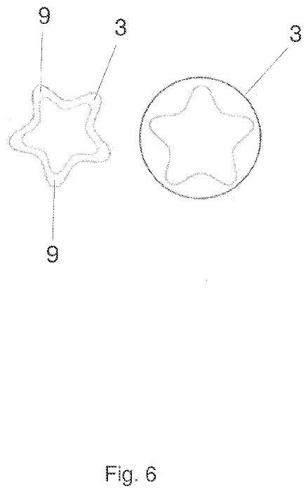

FIG. 6 shows a casing 3 which is designed to accept several storage cells 2. In this case, several storage cells 2 can be inserted next to one another into a separate passage in each case. The passages are each contoured on the inside and are star-shaped when viewed in plan view.

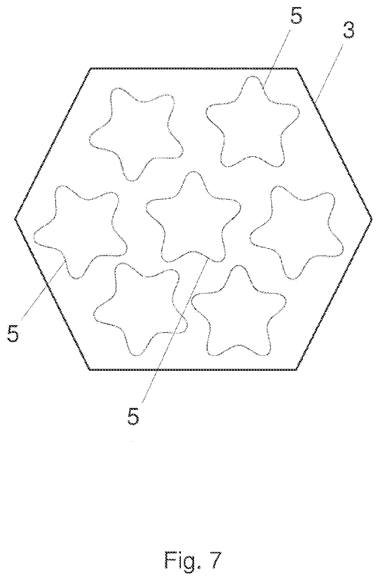

FIG. 7 shows a development of the casing 3 as shown in FIG. 6. In the present embodiment, a plurality of storage cells 2 can be placed in a single casing 3. In the present embodiment, the casing 3 has a hexagonal contour on the outside and is designed to accept seven storage cells 2 in each case in a separate passage contoured on the inside.

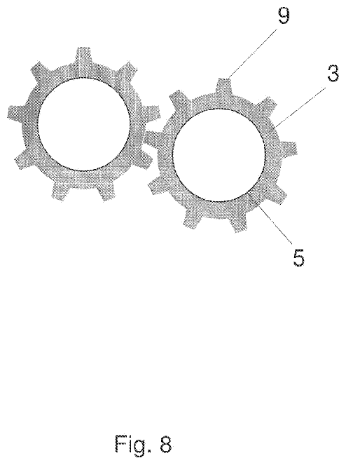

FIG. 8 shows an arrangement of two casings 3, each of which accepts one storage cell 2. The casings 3 are contoured on the outside and have longitudinal ribs 9 projecting radially outwards.

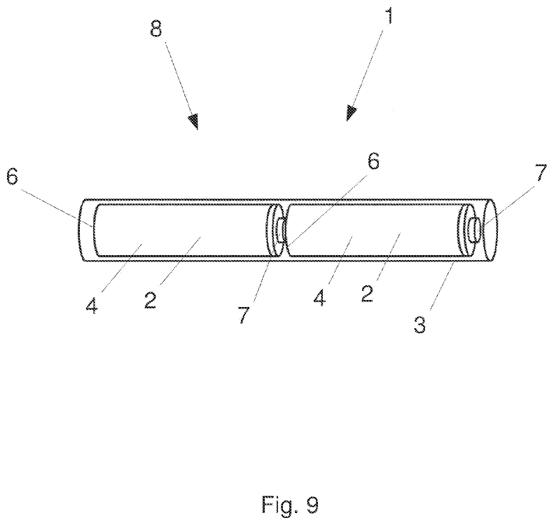

FIG. 9 shows an arrangement 8 of storage cells 2, wherein several storage cells 2 are arranged coaxially to one another and are surrounded by a single, tube-shaped casing 3. In this embodiment, the casing 3 functions as a carrier for a number of storage cells 2.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. An energy storage system, the energy storage system comprising at least one storage cell, wherein the at least one storage cell is provided, at least in sections, with a casing, wherein the casing consists of plastic, wherein the casing is provided with a material for increasing the a thermal conductivity.

2. The energy storage system according to claim 1, wherein the casing is configured to be elastic.

3. The energy storage system according to claim 1, wherein the at least one storage cell is a round cell.

4. The energy storage system according to claim 1, wherein the casing surrounds a sheath of the at least one storage cell at least in sections.

5. The energy storage system according to claim 1, wherein the casing is configured to be electrically insulating.

6. The energy storage system according to claim 1, wherein the casing is formed from elastomeric material.

7. The energy storage system according to claim 1, wherein the casing is configured to be tubular.

8. The energy storage system according to claim 1, wherein the casing is formed from sheeting.

9. The energy storage system according to claim 1, wherein the casing abuts with pretension on a sheath of the at least one storage cell.

10. The energy storage system according to claim 1, wherein the material for increasing the thermal conductivity is an electrically-insulating, inorganic filler.

11. The energy storage system according to claim 1, wherein the material for increasing the thermal conductivity is an endothermically-acting filler.

12. The energy storage system according to claim 1, wherein the casing is contoured on a side facing the at least one storage cell.

13. The energy storage system according to claim 1, wherein the casing is contoured on an outside.

14. The energy storage system according to claim 1, wherein the casing transfers heat emitted by the at least one storage cell to a cooler.

15. The energy storage system according to claim 14, wherein the casing lies flat against the cooler.

16. An energy storage system comprising:
at least one storage cell; and
a casing disposed on at least one storage cell at least in sections and comprising a plastic and a further material with a greater thermal conductivity than the plastic.
